(19) United States
(12) Patent Application Publication
(10) Pub. No.: US 2011/0002085 A1
(43) Pub. Date: Jan. 6, 2011

(54) Electrode for capacitor and electric double layer capacitor having the same

(75) Inventors: Jun Hee Bae, Suwon (KR); Hyun Chul Jung, Yongin (KR); Hak Kwan Kim, Hanam (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/656,986

(22) Filed: Feb. 22, 2010

(30) Foreign Application Priority Data
Jul. 6, 2009 (KR) 10-2009-0061332

(51) Int. Cl. H01G 9/00; H01B 5/00

(52) U.S. Cl. 361/502; 361/503; 361/523; 427/80; 174/126.1

(57) ABSTRACT

There are provided an electrode for a capacitor and an electric double layer capacitor having the same. The electrode for a capacitor may include: activated carbon; and 25 to 75 parts by weight of carbon aerogel per 100 parts by weight of the activated carbon. The electrode according to an aspect of the invention has excellent bonding strength between electrode materials and is free of defects such as aggregation and cracking. An electric double layer capacitor having this electrode has high capacitance and low internal resistance.

### CROSS-REFERENCE TO RELATED APPLICATIONS

This application claims the priority of Korean Patent Application No. 10-2009-0061332 filed on Jul. 6, 2009, in the Korean Intellectual Property Office, the disclosure of which is incorporated herein by reference.

### BACKGROUND OF THE INVENTION

1. Field of the Invention

The present invention relates to an electrode for a capacitor and an electric double layer capacitor having the same, and more particularly, to an electrode for a capacitor that has high capacitance and low internal resistance and an electric double layer capacitor having the same.

2. Description of the Related Art

Super capacitors have characteristics between electrolytic capacitors and secondary batteries. In comparison with secondary batteries, super capacitors have faster charging times, offer longer life, allow for higher power output and have higher energy density.

Therefore, super capacitors, which can be charged and discharged with high currents, have recently came to prominence as charge storage devices, which requires repeated charge and discharge cycles, such as auxiliary power supplies for cellular phones, auxiliary batteries for electric cars and auxiliary batteries for solar cells.

Super capacitors may be divided into electric double layer capacitors (EDLCs) that store electricity by the electrostatic adsorption and desorption of ions at the electrode-electrolyte interface, pseudo capacitors that accumulate electricity through reduction and oxidation, and hybrid capacitors having asymmetric electrodes.

In general, an electric double layer capacitor has a pair of polarizable electrode layers and an ion permeable separation membrane interposed therebetween while each of the polarizable electrode layers is impregnated with an electrolyte. This electric double layer capacitor utilize physical absorption and desorption. That is, charging is performed as a cation and an anion in the electrolyte are adsorbed onto each of the polarizable electrodes when an electric field is applied from the outside, and discharging is performed as the adsorbed ions are desorbed by removing the electric field.

Different from secondary batteries that utilizes chemical reactions, electric double layer capacitors make use of charging on the basis of surface chemical reactions or the simple movement of ions toward the electrode-electrolyte interface. Therefore, electric double layer capacitors have high charge and discharge efficiency and a semi-permanent life cycle. However, electric double layer capacitors are limited in terms of utilization due to the low capacitance thereof, and thus efforts have been made to increase the capacitance of the electric double layer capacitors.

One of the most important factors in determining the performance of an electric double layer capacitor is the material selected to form electrodes. Here, electrode materials need to have high electrical conductivity, a large specific surface area, electrochemical stability, and low costs.

Porous carbon-based electrode materials have enjoyed commercial success and are currently into production to manufacture electric double layer capacitors. However, there is a need to improve the capacitance of capacitors by forming electrodes having low resistance and high energy density by selecting appropriate electrode materials.

### SUMMARY OF THE INVENTION

An aspect of the present invention provides an electrode for a capacitor that has high capacitance and low internal resistance and an electric double layer having the same.

According to an aspect of the present invention, there is provided an electrode for a capacitor, including: activated carbon; and 25 to 75 parts by weight of carbon aerogel per 100 parts by weight of the activated carbon.

A diameter ratio of the carbon aerogel to the activated carbon may be within a range of 0.4 to 0.8.

The electrode for a capacitor may further include 5 to 25 parts by weight of ketjen black per 100 parts by weight of the activated carbon.

A diameter ratio of the ketjen black to the activated carbon may be within a range of 0.1 to 0.6.

The electrode for a capacitor may further include a polymer binder.

The polymer binder may be at least one selected from the group consisting of carboxymethyl cellulose, styrene butadiene rubber and polytetrafluoroethylene.

According to another aspect of the present invention, there is provided a method of manufacturing an electrode for a capacitor, the method including: mixing an active material including 10 to 30 parts by weight of activated carbon and carbon aerogel, 1 to 5 parts by weight of polymer binder, and 60 to 80 parts by weight of solvent to obtain a mixture; and coating metallic foil with the mixture and drying the metallic foil coated with the mixture.

The active material may include 25 to 75 parts by weight of carbon aerogel per 100 parts by weight of activated carbon.

The active material may further include 5 to 25 parts by weight of ketjen black per 100 parts by weight of activated carbon.

According to another aspect of the present invention, there is provided an electric double layer capacitor including: first and second electrodes including activated carbon and 25 to 75 parts by weight of carbon aerogel per 100 parts by weight of the activated carbon; an ion permeable separation membrane provided between the first and second electrodes; and an electrolyte with which the first and second electrodes are impregnated.

The first and second electrodes may further include 5 to 25 parts by weight of ketjen black per 100 parts by weight of the activated carbon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically illustrating an electric double layer capacitor according to an exemplary embodiment of the present invention;

FIG. 2 is an enlarged sectional view illustrating an electrode according to an exemplary embodiment of the present invention;

FIG. 3 is a graph illustrating the electrical characteristics of electrodes according to Inventive and Comparative Examples of the present invention;

FIG. 4 is an SEM photograph illustrating an electrode surface according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

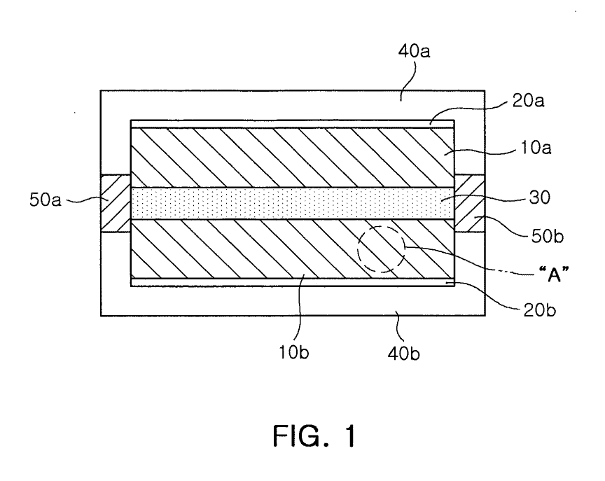

FIG. 1 is a cross-sectional view schematically illustrating an electric double layer capacitor according to an exemplary embodiment of the invention.

Referring to FIG. 1, an electric double layer capacitor according to this embodiment includes first and second electrodes 10a and 10b, an ion permeable separation membrane 30 interposed between the first and second electrodes 10a and 10b, and an electrolyte with which the first and second electrodes are impregnated, thereby forming one basic cell.

First and second collectors 20a and 20b may be formed on the first and second electrodes 10a and 10b, respectively. First and second metal cases 40a and 40b may be formed on the first and second collectors 20a and 20b, respectively. First and second gaskets 50a and 50b may be included in order to prevent contact between the first and second metal cases 40a and 40b.

The ion permeable separation membrane 30 keeps the first and second electrodes from making physical contact therebetween to thereby prevent short circuits. The first and second collectors 20a and 20b store positive and negative charges, respectively, when an electric field is applied from the outside. The first and second collectors are not particularly limited, and metals, such as Al, Cu or Ni—Cr, may be used therefor.
The first and second electrodes may include activated carbon and 25 to 75 parts by weight of carbon aerogel per 100 parts by weight of the activated carbon.

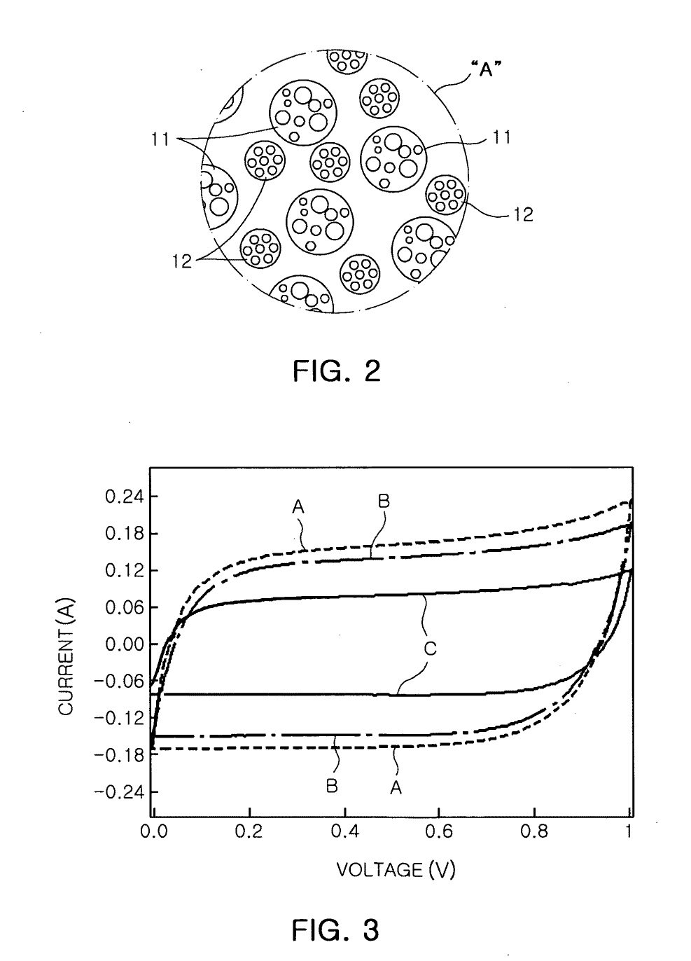

FIG. 2 is an enlarged sectional view illustrating an electrode region A according to an exemplary embodiment of the invention. Referring to FIG. 2, an electrode has activated carbon 11 and carbon aerogels 12 mixed therein.

Activated carbon 11 is not particularly limited and may be made from various materials such as plant materials (wood and coconut shells), coal/petroleum pitch, high molecular substances, or biomass. Furthermore, the specific surface area of the activated carbon is not particularly limited, and the activated carbon may have a specific surface area of 1500-2500 m²/g. With an increase in a mesoporous volume, high power capacitors that allow rapid charging and discharging can be manufactured.

The carbon aerogels 12 have a relatively smaller specific surface area than the activated carbon. However, the carbon aerogels have high electrical conductivity since their pores are of uniform size and the size of these pores can be controlled. The carbon aerogels 12 are not particularly limited as long as they are generally used in the art. For example, carbon aerogels may be prepared by forming wet gel by hydrolysis and polymerization of resorcinol and formaldehyde in an aqueous solution, drying the wet gel while maintaining the structure of the wet gel, forming RF-aerogel, and then pyrolyzing the RF-aerogel.

In general, it is difficult to mix activated carbon and carbon aerogels, and thus there is difficulty in forming electrodes due to the technically challenging nature of applying a mixture thereof.

However, it is possible to increase bonding strength between electrode materials by controlling a mixing ratio between the activated carbon 11 and carbon aerogels 12. The mixture thereof may comprise 25 to 75 parts by weight of carbon aerogel per 100 parts by weight of activated carbon. Preferably, 35 to 60 parts by weight, in particular, 50 parts by weight of carbon aerogel per 100 parts by weight of activated carbon may be used. When less than 25 parts by weight of carbon aerogel is used, the electrode surfaces may suffer from cracking, and internal resistance may increase due to low electrical conductivity. When more than 75 parts by weight of carbon aerogel is used, aggregation may occur on the electrode surfaces, and capacitance may be reduced due to a small specific surface area.

The packing density of the electrodes can be increased by including the carbon aerogels 12 having a smaller diameter than the activated carbon 11. A diameter ratio of the carbon aerogel 12 to the activated carbon 11 may be within the range of 0.4 to 0.8. However, the invention is not limited thereto. When the diameter ratio is out of the above range, the packing density may decrease, and internal resistance may increase.

Though not illustrated in the drawings, the first and second electrodes may further include conductive materials in order to increase electrical conductivity. Conductive materials are not particularly limited, and carbon black, acetylene black or graphite may be used therefor. However, this invention is not limited thereto.

The first and second electrodes 10a and 10b may further include ketjen black. Ketjen black has a uniform pore size and high electrical conductivity. When the first and second electrodes 10a and 10b include ketjen black, they may not additionally include conductive materials. The ketjen black may have a specific surface area in the range of 800 to 1500 m²/g. However, the invention is not limited thereto.

When ketjen black is included, 5 to 25 parts by weight of ketjen black per 100 parts by weight of the activated carbon may be included. Preferably, 10 to 15 parts by weight, particularly preferably 15 parts by weight, of ketjen black per 100 parts by weight of activated carbon may be used. When less than 5 parts by weight of ketjen black is used, the electrode surfaces may suffer from cracking, and electrical conductivity may not significantly increase. When more than 25 parts by weight of ketjen black is used, aggregation may occur on the electrode surfaces, and capacitance may be reduced.

When ketjen black is included, 35 parts by weight of carbon aerogel and 15 parts by weight of ketjen black per 100 parts by weight of activated carbon may be included.

A diameter ratio of the ketjen black to the activated carbon may be in the range of 0.1 to 0.6. When the diameter ratio thereof is out of the above range, the packing ratio may decrease and electrical conductivity may not be significantly improved.

The first and second electrodes 10a and 10b may further include a polymer binder. The polymer binder is not particularly limited, and may use at least one polymer binder selected from the group consisting of carboxymethyl cellulose, styrene butadiene rubber and polytetrafluoroethylene.

Hereinafter, a method of manufacturing an electrode according to an exemplary embodiment of the invention will be described.

First, an active material containing 10 to 30 parts by weight of activated carbon and carbon aerogel and 1 to 5 parts by weight of polymer binder is mixed in 60 to 80 parts by weight of solvent. Preferably, 16 parts by weight of the active material and 2 parts by weight of the polymer binder may be mixed.

Here, the active material may include 100 parts by weight of activated carbon and 25 to 75 parts by weight of carbon aerogel. The solvent is not particularly limited, and DI water or an organic solvent may be used. The organic solvent is not particularly limited, and methyl alcohol, ethyl alcohol or isopropyl alcohol may be used therefor.

The entire surface of a collector formed of a metal is coated with this mixed slurry, which is then dried to thereby manufacture an electrode.

A method of coating the collector with the mixed slurry is not particularly limited. For example, the collector may be coated with the mixed slurry using a doctor blade coater, a comma coater, a die coater, a gravure coater or a micro gravure coater.

The active material may further include 5 to 25 parts by weight of ketjen black per 100 parts by weight of activated carbon.

A method of manufacturing an electric double layer capacitor is not particularly limited. For example, electrodes, formed on collectors, serve as first and second electrodes, and an ion permeable separation membrane is deposited between first and second electrode layers. The first and second electrode layers are then impregnated with an electrolyte and sealed. After depositing the separation membrane, the first and second electrodes and the collectors may be pressurized in order to increase the bonding strength therebetween. First and second metal cases may be formed on the collectors, and gaskets may be formed between the first and second metal cases.

### Inventive Example 1

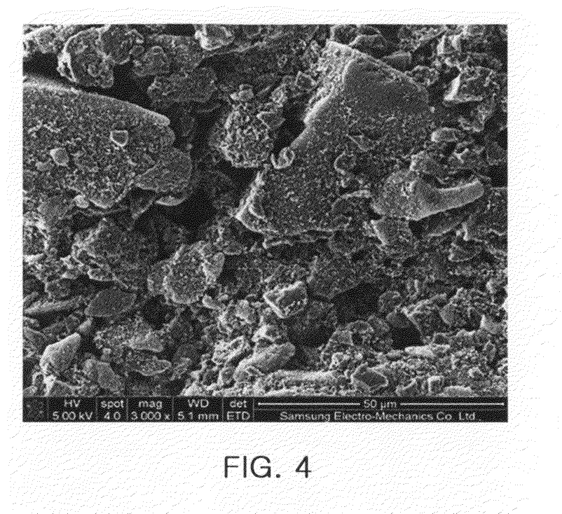

Mixed slurry was prepared by mixing 16 parts by weight of an active material (100 parts by weight of activated carbon and 50 parts by weight of carbon aerogel), 2 parts by weight of acetylene black and 2 parts by weight of polymer binder with DI water. This mixed slurry was applied to aluminum foil and dried for 48 hours to form an electrode. FIG. 4 is an SEM photograph of the electrode.

### Inventive Example 2

Mixed slurry was prepared by mixing 16 parts by weight of an active material (100 parts by weight of activated carbon, 35 parts by weight of carbon aerogel, and 15 parts by weight of ketjen black) and 2 parts by weight of polymer binder with DI water. An electrode was formed using the same method as that of the Inventive Example 1.

### Comparative Example 1

An electrode active material was formed using the same method as that of Inventive Example 1 except that 100 parts by weight of activated carbon was used as an active material.

### Comparative Example 2

An electrode active material was formed using the same method as that of Inventive Example 1 except that 100 parts by weight of activated carbon and 22.5 parts by weight of carbon aerogel were used as an active material.

### Comparative Example 3

An electrode was formed using the same method as that of Inventive Example 1 except that 300 parts by weight of carbon aerogel was used as an active material.

The electrical characteristics of the electrodes formed according to the Inventive Example 1 (B), the Inventive Example 2 (A) and the Comparative Example 1 (C) were measured (using equipment WMPG-1000 manufactured by WonAtech), and the results thereof were shown in FIG. 3. Referring to FIG. 3, the electrodes formed according to Inventive Examples are shown to have electrical characteristics superior to those of Comparative Examples.

As set forth above, according to exemplary embodiments of the invention, an electrode for a capacitor includes activated carbon having a large specific surface area and carbon aerogels having high electrical conductivity to thereby allow for rapid charging and discharging and obtain high power properties, and internal resistance can be reduced because of low contact resistance with collectors. Furthermore, since high bonding strength is obtained between electrode materials, electrodes free of defects such as aggregation or cracking can be manufactured. Therefore, an electric double layer capacitor having this electrode has high capacitance and low internal resistance to thereby improve performance thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. An electrode for a capacitor, comprising:
activated carbon; and
25 to 75 parts by weight of carbon aerogel per 100 parts by weight of the activated carbon.

2. The electrode for a capacitor of claim 1, wherein a diameter ratio of the carbon aerogel to the activated carbon is within a range of 0.4 to 0.8.

3. The electrode for a capacitor of claim 1, further comprising 5 to 25 parts by weight of ketjen black per 100 parts by weight of the activated carbon.

4. The electrode for a capacitor of claim 3, wherein a diameter ratio of the ketjen black to the activated carbon is within a range of 0.1 to 0.6.

5. The electrode for a capacitor of claim, further comprising a polymer binder.

6. The electrode for a capacitor of claim 5, wherein the polymer binder is at least one selected from the group consisting of carboxymethyl cellulose, styrene butadiene rubber and polytetrafluoroethylene.

7. A method of manufacturing an electrode for a capacitor, the method comprising:
mixing an active material comprising 10 to 30 parts by weight of activated carbon and carbon aerogel, 1 to 5 parts by weight of polymer binder, and 60 to 80 parts by weight of solvent to obtain a mixture; and
coating metallic foil with the mixture and drying the metallic foil coated with the mixture.

8. The method of claim 7, wherein the active material comprises 25 to 75 parts by weight of carbon aerogel per 100 parts by weight of activated carbon.

9. The method of claim 7, wherein the active material further comprises 5 to 25 parts by weight of ketjen black per 100 parts by weight of activated carbon.

10. An electric double layer capacitor comprising:
first and second electrodes comprising activated carbon and 25 to 75 parts by weight of carbon aerogel per 100 parts by weight of the activated carbon;
an ion permeable separation membrane provided between the first and second electrodes; and
an electrolyte with which the first and second electrodes are impregnated.

11. The electric double layer capacitor of claim 10, wherein the first and second electrodes further comprise 5 to 25 parts by weight of ketjen black per 100 parts by weight of the activated carbon.
